(19) United States
(12) Patent Application Publication
(10) Pub. No.: US 2011/0208828 A1
(43) Pub. Date: Aug. 25, 2011

(54) NODE APPARATUS AND COMPUTER-READABLE STORAGE MEDIUM FOR COMPUTER PROGRAM

(75) Inventors: Hironori SAKAKIHARA, Kawasaki (JP); Toru Kamiwada, Kawasaki (JP); Kiyohiko Ishikawa, Tokyo (JP); Hisayuki Ohmata, Tokyo (JP)

(73) Assignees: FUJITSU LIMITED, Tokyo (JP); NIPPON HOSO KYOKAI, Tokyo (JP)

(21) Appl. No.: 13/032,141

(22) Filed: Feb. 22, 2011

(30) Foreign Application Priority Data
Feb. 24, 2010 (JP) JP2010-038871

(51) Int. Cl. G06F 15/16

(52) U.S. Cl. 709/217

(57) ABSTRACT

A node apparatus includes a second computation portion that references cache information held by the own node apparatus, the cache information indicating a node holding an object that is a search target in an overlay network in association with the object, and calculates, with respect to the object corresponding to the node indicated in the cache information, a distance between an object location and a node of interest in a logical space in which the overlay network is constructed, the object location being a logical location of the object, and the node of interest being a node other than the own node, and a transfer destination selection portion that selects a transfer destination to which the cache information is to be transferred, based on the distance calculated by the second computation portion. The cache information is transferred to the transfer destination selected by the transfer destination selection portion.

### CROSS-REFERENCE TO RELATED APPLICATION

This application is based upon and claims the benefit of priority of the prior Japanese Patent Application No. 2010-038871, filed on Feb. 24, 2010, the entire contents of which are incorporated herein by reference.

### FIELD

The present invention relates to a node apparatus that is connected to a network employing a distributed hash table, and a computer program that realizes the functionality of the node apparatus.

### BACKGROUND

In a peer-to-peer (hereinafter, referred to as “P2P”) network, a distributed hash table (hereinafter, referred to as a “DHT”) is used as a routing technique. A DHT constructs an overlay network by mapping nodes to a hash space, which is a collection of hash values determined by a predetermined hash function. For example, with an overlay network in which a plurality of nodes share various types of content such as video, audio, and software, the location of each content piece is managed by a respectively determined node. The location of a certain content piece is managed by a node that is close to the hash value determined for that content piece in the hash space. The node that manages the location of a content piece holds cache information indicating the node that holds the actual content piece, as index information for content searching. This enables any node to acquire a content piece held by another node. Specifically, any node obtains a hash value for the content piece that is to be acquired, sends an inquiry for the location of the content piece to a node corresponding to the obtained hash value, and receives the content piece by communicating with a node that holds the content piece. A DHT enables all of the nodes participating in a network to quickly search each other for content through P2P communication.

In a network in which nodes participate and leave as needed, in order to prevent the disappearance of cache information due to the exit of a location managing node, the cache information for each content piece is periodically re-registered or redundantly held by a plurality of nodes. For example, a technique is proposed in which the own node monitors the connection state of a location managing node that is a communication partner in which cache information has been registered, and if the own node detects that the location managing node has been disconnected, the own node determines a new node and re-registers the cache information (Japanese Laid-open Patent Publication No. 2006-246225). Also, an authentication system is disclosed in which a plurality of nodes that are to redundantly store the same cache information are selected based on distances in the hash space (Japanese Laid-open Patent Publication No. 2009-169861). In this authentication system, an authentication node checks the validity of an authentication target node based on verification information regarding the authentication target node that is recorded in a plurality of other nodes, and this authentication system includes a management node that manages all of the nodes. The management node causes the verification information (cache information) regarding the authentication target node to be recorded in a plurality of nodes whose distance from the hash value of such verification information is a less than or equal to a predetermined value, that is to say, a plurality of nodes that are close to such verification information. The management node obtains distances by performing an exclusive OR operation on hash values.

Meanwhile, in order to alleviate the processing burden of network management, there is proposed the provision of a means for controlling the node connection from midway in the tree of a network that has a hierarchical tree structure (Japanese Laid-open Patent Publication No. 2008-252498). A first sub-network is configured by information processing apparatuses that are connected in a hierarchical tree shape whose apex is a distribution source apparatus. Any one of the information processing apparatuses in the first sub-network is considered to be an apex information processing apparatus, and a second sub-network is configured by information processing apparatuses that are connected in a hierarchical tree shape whose apex is the apex information processing apparatus. The apex information processing apparatus manages connections in the second sub-network, thus alleviating the burden of connection management in the network as a whole.

Even if a plurality of nodes redundantly hold cache information, such cache information will disappear if all of those nodes leave the network. Other examples of problems that may occur include, in the case where the cache information is a content location management list indicating nodes that are holding content, a content search request has been transmitted but a content acquisition location cannot be obtained, and in the case where the cache information is node verification information, a node is not properly authenticated even though it is a legitimate node. When a managing node has left the network, the disappearance of cache information may be prevented if a node that is holding a content piece related to the cache information re-determines a managing node and re-registers the cache information. Also, in Japanese Laid-open Patent Publication No. 2009-169861, when a node holding verification information, which serves as cache information, has left the network, the management node that manages all of the nodes re-determines a node that is to hold the verification information and re-distributes the verification information, thus enabling the authentication system to function. However, with this configuration, each of the nodes is required to store information indicating a managing node for each content piece that the node holds, and furthermore, each of the nodes is required to frequently perform connection confirmation in order to detect whether a managing node has left the network. As the number of content pieces shared on a network increases, there is a rise in the amount of traffic performed for connection confirmation. Raising the amount of traffic performed by a specific management node for connection confirmation, the redistribution of verification information, or the like as in Japanese Laid-open Patent Publication No. 2009-169861 detracts from the advantages of P2P.

### SUMMARY

According to an aspect of the invention (embodiment), a node apparatus capable of communicating, as a node in an overlay network, with another node in the overlay network, is provided. The node apparatus includes a second computation portion that references cache information held by the own node corresponding to the node apparatus, the cache information indicating a node holding an object that is a search target in the overlay network in association with the object, and calculates, with respect to the object corresponding to the node indicated in the cache information, a distance between an object location and a node of interest in a logical space in which the overlay network is constructed, the object location being a logical location of the object, and the node of interest being a node other than the own node, a transfer destination selection portion that selects a transfer destination to which the cache information is to be transferred, based on the distance calculated by the second computation portion, and an information transfer portion that transfers the cache information to the transfer destination selected by the transfer destination selection portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of a network;

FIG. 2A is a diagram illustrating an example of a routing table, and FIG. 2B illustrates a relationship between a bucket number and a node in a binary tree of hash values;

FIG. 3 is a diagram illustrating an example of distances between hash values;

FIG. 4 is a diagram schematically illustrating distance relationships between a node and other nodes in its vicinity;

FIG. 5 is a diagram illustrating a first example of the configuration of a node apparatus;

FIG. 6 is a diagram illustrating an example of cache information;

FIG. 7 is a flowchart illustrating an overview of operations performed by the node apparatus;

FIG. 8 is a flowchart illustrating a flow of operations performed in the case of joining a network;

FIG. 9 is a flowchart illustrating a flow of transfer operations in a normal case;

FIG. 10 is a flowchart illustrating a flow of transfer operations in the case of leaving the network;

FIGS. 11A and 11B are diagrams illustrating an example of cache information transfer in a normal case;

FIGS. 12A to 12C are diagrams illustrating a first example of cache information transfer in the case of leaving the network;

FIGS. 13A to 13C are diagrams illustrating a second example of cache information transfer in the case of leaving the network;

FIG. 14 is a diagram illustrating a second example of the configuration of a node apparatus;

FIG. 15 is a flowchart illustrating a flow of operations performed by a transfer management portion;

FIG. 16 is a diagram illustrating an embodiment of cache information transfer performed by the node apparatus according to the second example in a normal case; and

FIGS. 17A to 17C are diagrams illustrating an embodiment of cache information transfer performed by the node apparatus according to the second example in the case of leaving the network.

### DESCRIPTION OF EMBODIMENTS

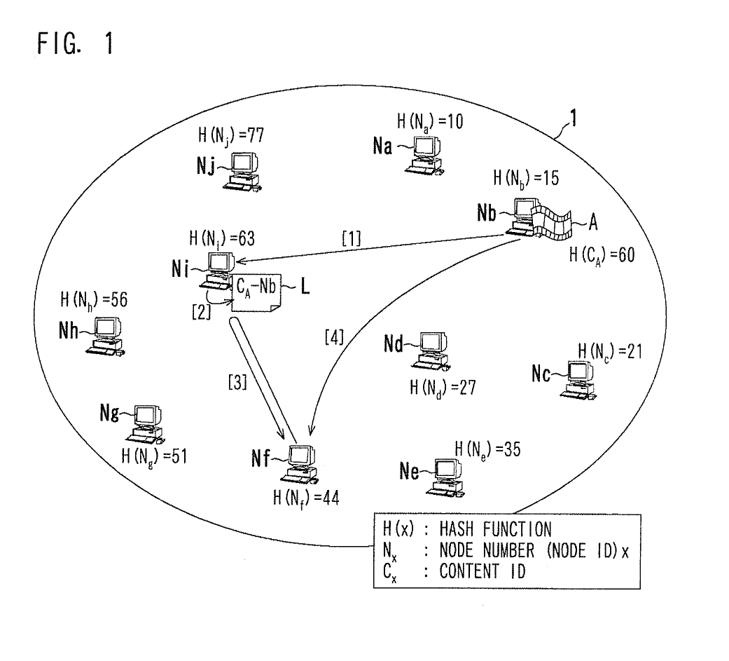

Firstly, assume a network 1 such as that illustrated in FIG. 1. The network 1 is an overlay network in which a plurality of node apparatuses configuring a P2P network are mapped to a hash space. A hash space is one type of n-dimensional logical space expressed by binary numbers having n digits (n being a natural number), and is a space in which the locations of nodes are determined by a hash function.

The network 1 includes nodes Na, Nb, Nc, Nd, Ne, Nf, Ng, Nh, Ni, and Nj that are illustrated in FIG. 1, as well as a plurality of nodes that are not illustrated. All of the nodes in the network 1 correspond to respective node apparatuses. Each of the node apparatuses is a personal computer, a personal digital assistant (PDA), or another information device that is connectable to a network. The nodes Na to Nj are each associated with a hash value as a location in the hash space, and each hash value is obtained by applying a hash function to the unique node ID of the corresponding node. In FIG. 1, the hash values of the nodes Na to Nj are illustrated in decimal notation for the sake of convenience.

In the network 1, a search (also referred to as a “look-up”) for an “object” is performed by a node that is not holding that object. When a search is performed, there are cases where the object is being held by a node, and it is also possible that the object is not being held by any of the nodes. One typical example of an object that is searched for is so-called content, such as video or audio. In the case where authentication information regarding a node is subjected to verification by another node, the verification information held by the other node is also an example of an object.

Cache information is defined as follows. Cache information is stored information that has been distributed by a P2P network, and is assumed to be data (e.g., a content location management list) serving as the basis on which a node that has received a key (hash value) that is being searched for determines whether some kind of value may be sent as a response, data (e.g., content or node verification information) serving as the basis on which, after having received a search response, information is provided upon requesting a connection-destination node described in the search response to perform processing. Specifically, in the case where the object being search for is a content piece (content ID=ID₀), a hash function Hash( ) is applied to the content ID to obtain a hash value Hash(ID₀), and a node that is close to this hash value is determined to manage information (a content location management list) indicating the node that is holding the content piece. In this case, cache information is defined as this content location management list. Also, in an authentication system such as that disclosed in the aforementioned Japanese Laid-open Patent Publication No. 2009-169861, the management node allocates verification information regarding a node (node ID=ID₀) to a plurality of nodes that are close to a hash value Hash(ID_{0+α}). In this case, one node holds verification information regarding another node, and cache information is defined as such node verification information. Here, a is assumed to be a constant set in the applied system. In the authentication system, the node that performs authentication on the authentication target node (node ID=ID₀) finds a node that is holding verification information regarding the authentication target node (node ID=ID₀) by searching for a node close to the hash value Hash(ID_{0+α}), and then transmits a verification request and receives a verification result. The node that is holding this cache information is a node that is associated with a hash value that is the same as or close to the hash value of the object identifier (ID₀ or ID_{0+α}). Since the hash value corresponds to a location in the hash space, this cache information is held by a node mapped to the logical location of the object (also referred to as the “object location”) or a location in the vicinity thereof. In other words, in a search performed in the network 1, the key is an object location, and the value is cache information or a value that has been determined based on cache information.

In the example illustrated in FIG. 1, a certain content piece A is exchanged between the node Nb and the node Nf. Here, the content piece A is assumed to be video data, or more specifically, a program or part of a program that is provided by communication or broadcast from a broadcast station. Note that the content piece A may be data other than video data. The basic procedure for exchanging the content piece A is as follows.

The node Nb acquires the content piece A by receiving a broadcast, and thereafter transmits a hold request to a node that is to hold cache information L_{A} regarding the content piece A (stage [1]). At this time, the hash value (i.e., the content location) of the content ID specifying the content piece A (may be the program name or the like) is assumed to be “60”. Also, the node closest to this content location is assumed to be the node Ni. The node Nb specifies the node Ni by performing routing in order to look up a node that is close to the content location, and transmits a predetermined message to the node Ni.

Upon receiving this message, the node Ni creates and holds the cache information L_{A} indicating that the content piece A is being held by the node Nb. As a result, the content piece A is registered as an object that is a search target (stage [2]). Note that in this registration, the node that transmitted the message serving as the trigger for registration (in this example, the node Nb) is called the registration source, and the node that received the message and registered the cache information (in this example, the node Ni) is called the registration destination.

Thereafter, the node Nf performs a search in order to acquire the content piece A, for example. The node Nf obtains the content location (the hash value of the content ID), and transmits a query for the location of the content piece A that is bound for a node close to the content location. This query is received by the node Ni that is holding the cache information L_{A} regarding the content piece A. The node Ni notifies the node Nf, which is the query transmission source, of address information regarding the node Nb, which is the location of the content piece A (stage [3]).

After receiving the response to the query, the node Nf attempts communication with the node Nb. If the node Nb has not left the network 1, and furthermore the content piece A has not been deleted from the node Nb, the content piece A is transferred from the node Nb to the node Nf (stage [4]).

According to such a procedure, any other arbitrary content piece located in the network 1 is also exchanged between predetermined nodes in the same way as the content piece A.

Routing in the network 1 may be performed using Kademlia, for example. Kademlia is one type of DHT algorithm. Kademlia is advantageous in that searches may be performed with high scalability, and the load borne by each node for route maintenance that accompanies the joining and leaving of nodes is small.

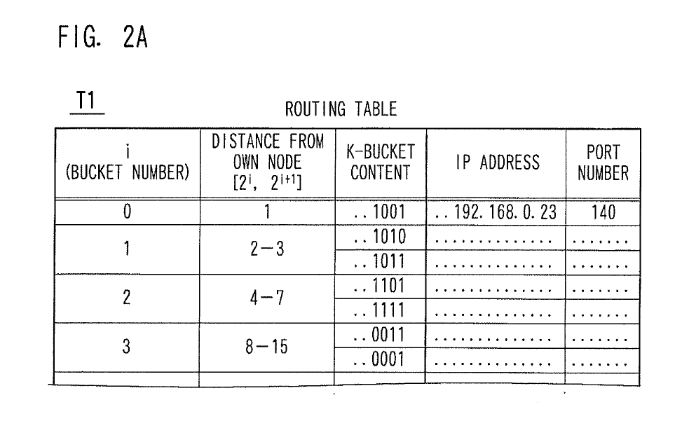

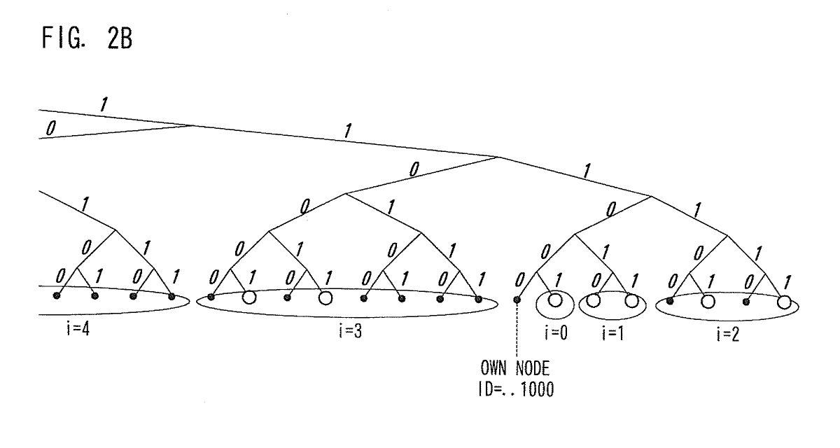

FIG. 2A illustrates the configuration of a routing table T1 pertaining to Kademlia. The routing table T1 is a list of connection destination nodes called K-buckets. A number of nodes up to a prescribed number (e.g., 8) are registered for each bucket number i, i being a value from 0 to the number of bits in the hash value. Information for network communication, such as an IP (Internet Protocol) address and a port number, is associated with the nodes that are to be registered. For example, if the hash function is SHA-1 (Secure Hash Algorithm 1), each hash value has 160 bits, and therefore the range of values taken by the bucket number i is 0 to 160. The bucket number i indicates the number of segments (i.e., the distance) between the own node holding the routing table T1 and a connection destination node. The value of each bucket number i corresponds to a distance greater than or equal to 2¹ and less than 2ⁱ⁺¹. The values of the distances illustrated in FIG. 2A are illustrated in decimal notation.

The hash values are illustrated in the form of a binary tree in FIG. 2B. FIG. 2B illustrates the node with the hash value whose four least significant bits are “1000” as the own node, and illustrates the nodes having the bucket numbers i that are 0 to 4. The italic numbers “0” and “1” in the binary tree indicate bit values. In FIG. 2B, the nodes are aligned at equal intervals in descending order of the size of their hash values, regardless of the distance between the nodes.

“Distance” in the network 1 of the present embodiment refers to an exclusive OR (XOR) between hash values corresponding to locations in the logical space in which the network 1 is constructed. For example, the distance between the value “11111B” and the value “11000B”, which are different with respect to the five least significant bits, is “111B” (“7” in decimal notation). Likewise to a distance in a Euclidian space, a distance defined by an exclusive OR is symmetrical in that the value as viewed from one of two points is equal to the value as viewed from the other point.

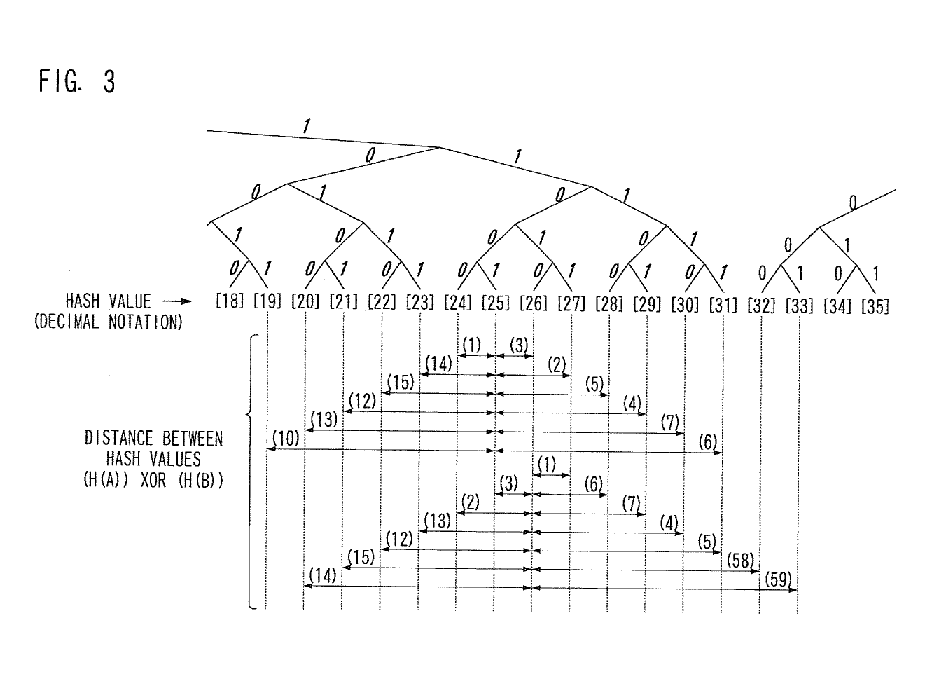

Although distances in the network 1 are symmetrical, the near/far relationship between three or more nodes differs depending on the node being focused on. In FIG. 3, the distance between, for example, a node [25] (the number inside brackets indicates the hash value in decimal notation) and a node [28] is “5” in decimal notation, and the distance between the node [25] and a node [29] is “4”. In other words, from the viewpoint of the node [25], the node [29] is closer than the node [28]. In contrast, the distance between a node [26] and the node [28] is “6”, and the distance between the node [26] and the node [29] is “7”. In other words, from the viewpoint of the node [26], the node [28] is closer than the node [29].

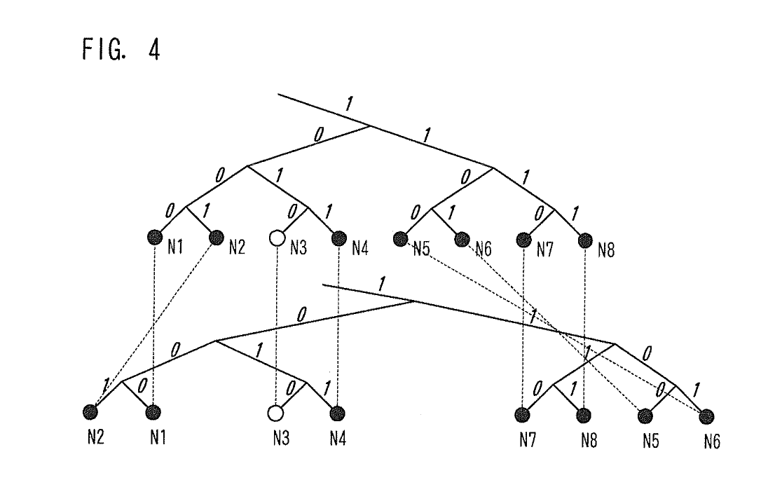

In the following description, reference is made as necessary to the binary tree depicted in the lower half of FIG. 4 that illustrates near/far relationships between nodes. The binary tree depicted in the lower half of FIG. 4 illustrates a modification of the binary tree depicted in the upper half, in which the nodes N1 to N8 are aligned at equal intervals. The binary tree depicted in the lower half of FIG. 4 illustrates the near/far relationships that the node N3, whose four least significant bits are the value “1010”, has with the other nodes N1, N2, and N4 to N8.

Next is a description of the configuration of and operations performed by a node apparatus that functions as one of the nodes in the network 1 described above.

[Node Apparatus According to First Example]

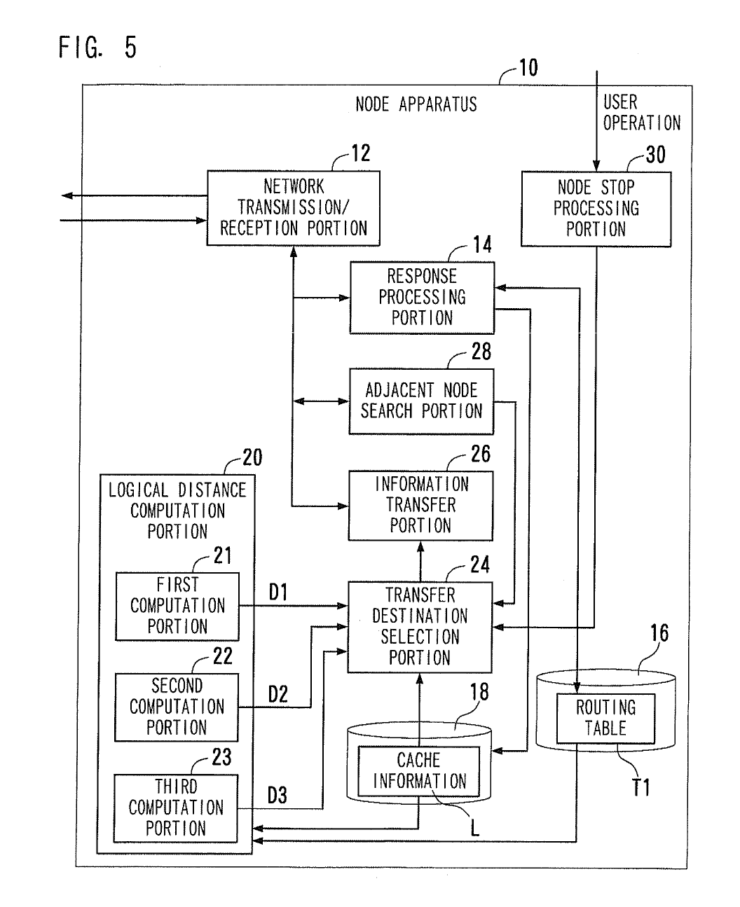

A node apparatus 10 illustrated in FIG. 5 includes a network transmission/reception portion 12, a response processing portion 14, a routing information holding portion 16, and a cache information holding portion 18, as software constituent elements for performing basic operations as a node. The node apparatus 10 also includes a logical distance computation portion 20, a transfer destination selection portion 24, an information transfer portion 26, an adjacent node search portion 28, and a node stop processing portion 30, as software constituent elements related to the transfer of cache information L. These elements are realized by a predetermined hardware element (not illustrated) executing a computer program.

The network transmission/reception portion 12 performs the transmission and reception of messages and queries with other node apparatuses in the network 1. Upon receiving a search request from another node apparatus, the network transmission/reception portion 12 passes the request to the response processing portion 14. If a search for the purpose of routing has been requested, the response processing portion 14 extracts information corresponding to the search request from the routing table T1, which is updated by the routing information holding portion 16. The information extracted by the response processing portion 14 is transmitted by the network transmission/reception portion 12 to the search request source node. If a request to hold the cache information L has been received, the response processing portion 14 requests the cache information holding portion 18 to perform processing. Upon receiving this request, the cache information holding portion 18 stores the cache information L in a predetermined memory. Thereafter, the cache information L is held until the node apparatus 10 leaves the network 1.

The fact that some kind of communication is being performed with another node apparatus, including the reception of a search request, means that another node is participating in the network 1. When some kind of communication has been performed, the routing information holding portion 16 maintains the routing table T1. If the other communication party is not registered in the routing table T1, the routing table T1 is updated by registering the other communication party at the end with respect to the bucket number i corresponding to the other communication party. At this time, a connection check is performed regarding the node at the head with respect to the bucket number i, and if the node at the head is not participating (online), it is deleted from the routing table T1. A configuration is possible in which, for each bucket number i, the connection check is performed only if a prescribed number (e.g., 8) of nodes or more are registered. With Kademlia, the routing table T1 is successively updated when normal communication is performed, and therefore dedicated communication for route maintenance is not necessary.

The logical distance computation portion 20 has a first computation portion 21, a second computation portion 22, and a third computation portion 23. The first computation portion 21 calculates a distance D1 between a content location and the own node, which is the node corresponding to the node apparatus 10. Specifically, the first computation portion 21 calculates the exclusive OR of the hash value of the own node ID and the hash value of the content ID. The second computation portion 22 calculates a distance D2 between the content location and one node being focused on (node of interest) among the nodes other than the own node. The third computation portion 23 calculates a distance D3 between the own node and the same node of interest that was the target of the computation performed by the second computation portion 22. Letting the hash function be expressed by “H(conversion target bit string)”, and the exclusive OR be expressed by the notation “̂”, the distances D1, D2, and D3 are expressed by the following equations.

D1=H(own node ID)̂H(content ID)

D2=H(node of interest ID)̂H(content ID)

D3=H(own node ID)̂H(node of interest ID)

The transfer destination selection portion 24 selects a transfer destination node in the case where the cache information L is to be transferred in order to be held redundantly by a plurality of nodes or to be delegated when leaving the network. The selection of a transfer destination is performed based on the distances D1, D2, and D3 calculated by the logical distance computation portion 20. This selection will be described in detail later. The transfer destination selection portion 24 notifies the information transfer portion 26 of one or more transfer destinations that have been selected.

In coordination with the network transmission/reception portion 12, the information transfer portion 26 transfers the cache information L held by the cache information holding portion 18 to the one or more transfer destinations selected by the transfer destination selection portion 24.

The adjacent node search portion 28 searches for an adjacent node, which is a node that is adjacent to the own node. Here, “adjacent node” refers to a node whose node ID is obtained by inverting the least significant bit of the hash value of the own node ID. In normal operation, the adjacent node search portion 28 requests an adjacent node search to be performed by the node that is the closest to the own node among the nodes registered in the routing table T1. The node that has received this request searches the routing table that it holds for a node corresponding to the request, and sends information regarding the node to the request source. Even if none of the nodes corresponds to the request at this time, a configuration is possible in which information regarding a predetermined number of nodes that are close to the node corresponding to the request is sent. The execution of such searching by the adjacent node search portion 28 is the trigger for the selection of a transfer destination by the above-described transfer destination selection portion 24.

The node stop processing portion 30 monitors for the input of an instruction causing the own node to leave the network 1. If this instruction has been input, the node stop processing portion 30 notifies the transfer destination selection portion 24 of the instruction. Upon receiving the instruction, the transfer destination selection portion 24 selects a transfer destination that is to be delegated the responsibility for holding the cache information L, and the information transfer portion 26 transfers the cache information L. The instruction whose input the node stop processing portion 30 monitors for is given to the node apparatus 10 by a user thereof through performing a predetermined operation using a user interface (not illustrated). Besides the case in which a user performs an operation, if an automatic exit function is provided, such an instruction is input to the node stop processing portion 30 when a preset automatic exit time has been reached.

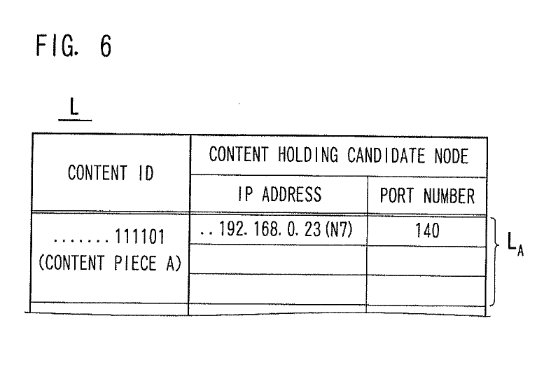

FIG. 6 illustrates an example of the cache information L. The cache information L of the present embodiment includes a hash value of the content ID of a certain content piece A, and the IP address and the port number of a node that is the registration source of the content piece A. The IP address and the port number are associated with the hash value of the content ID. If SHA-1 is applied to the content ID, the hash value of the content ID has a length of 2¹⁶⁰ bits. There are also cases where a plurality of the content pieces A having the same content ID are held by different nodes, and accordingly there are a plurality of registration sources corresponding to the same content ID. In such a case, a plurality of sets of an IP address and a port number are registered in correspondence with the same content ID. Also, the number of content pieces is not limited to one, and there are cases in which sets of an IP address and a port number for a plurality of registration sources are registered in correspondence with a plurality of content pieces having hash values that are close to the hash value of the content ID of the content piece A. In such a case, when an inquiry for the content piece A is made, information regarding a portion L_{A} of the cache information L, which pertains to the content piece A, is sent to the inquiry source. In any case, there are cases where registration source nodes leave the network, content pieces are deleted, or the like. Accordingly, strictly speaking, the cache information L is not information indicating the location of a content piece, but rather information indicating location candidates. In this sense, the cache information L may be called a “content possession candidate list”.

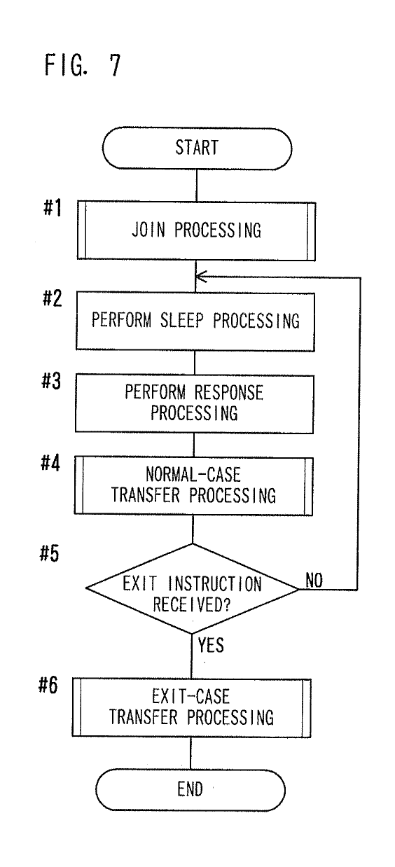

Next is a description of the flow of operations performed by the node apparatus 10 having the above-described configuration, with reference to the flowcharts in FIGS. 7 to 10.

As illustrated in FIG. 7, the node apparatus 10 that has joined the network 1 first constructs routing information by executing join processing (step S1). After completing the join processing, the node apparatus 10 transitions to a standby state (sleep) by executing sleep processing (step S2). If an event such as a sleep cancellation, which is triggered by the input of a message from another node apparatus or the elapse of a certain time period, has occurred, the node apparatus 10 reverts from the standby state to a normal operation state, and executes response processing for communicating with another node apparatus (step S3). If the node apparatus 10 has received a request to hold the cache information L from a registration source node or a node that is in the vicinity and has a transfer function similar to that of the node apparatus 10, the cache information holding portion 18 stores the cache information L in the response processing. Subsequently, the node apparatus 10 executes normal-case transfer processing for causing the cache information L to be held redundantly (step S4). If an exit instruction has been given, the node apparatus 10 executes exit-case transfer processing for delegating the responsibility for holding the cache information L (steps S5 and S6), and if an exit instruction has not been given, the node apparatus 10 repeatedly executes the processing of steps S2 to S4.

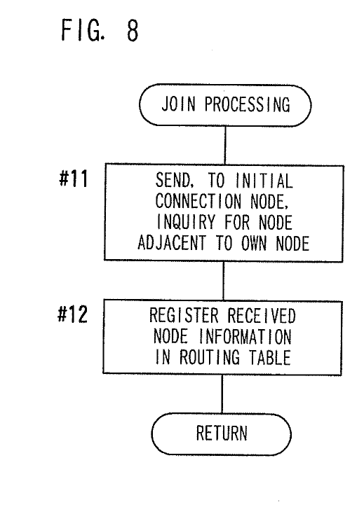

In the join processing illustrated in FIG. 8, the adjacent node search portion 28 requests a predetermined initial connection node to search for an adjacent node (step S11). Upon receiving information regarding a plurality of nodes in the vicinity that includes or does not include an adjacent node as a response, the adjacent node search portion 28 registers information in the routing table T1 in coordination with the routing information holding portion 16 (step S12).

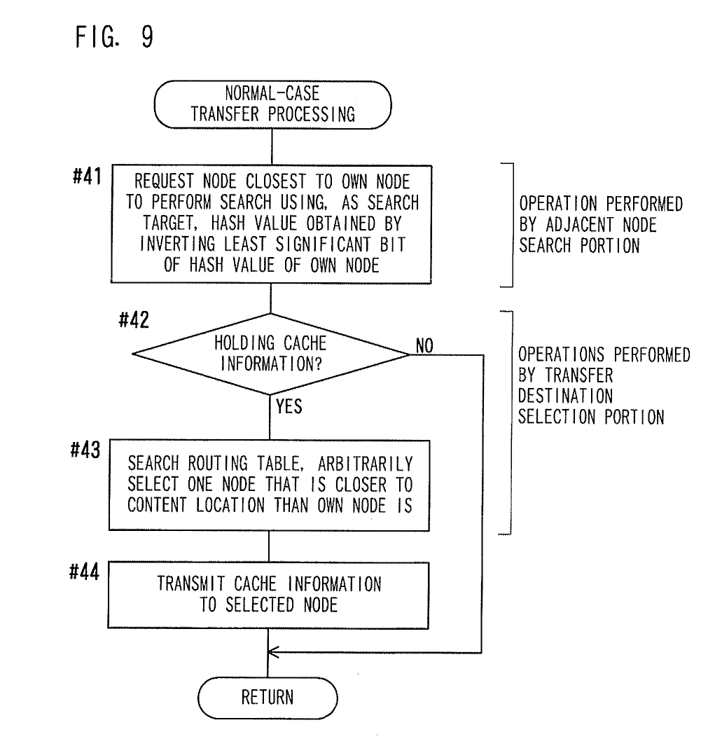

In the normal-case transfer processing illustrated in FIG. 9, the adjacent node search portion 28 requests the node that is the closest to the own node to search for an adjacent node, as described above (step S41). As a result, the node apparatus 10 becomes aware of the existence of a node that is in close proximity with its own node in the hash space. Using this as a trigger, only in the case where the cache information L is held in the own node (YES in step S42), the transfer destination selection portion 24 selects a transfer destination (step S43), and the information transfer portion 26 transfers the cache information L (step S44). The transfer destination is selected as described below.

The logical distance computation portion 20 extracts, from among the nodes registered in the routing table T1, a predetermined number (e.g., 8) of nodes in ascending order of the bucket number i. The logical distance computation portion 20 calculates the distances D1 and D2 sequentially using the extracted nodes as the node of interest. The transfer destination selection portion 24 determines each node that satisfies the condition that the distance D2 is less than the distance D1 (D1>D2), that is to say, each node that is closer to the content location than the own node is, as a transfer destination candidate. The transfer destination selection portion 24 randomly selects one of the transfer destination candidates, and determines the selected candidate to be the transfer destination. As a result of such selection, the cache information L ends up being held in a location closer to the content location.

Since the search performed by the adjacent node search portion 28, which is the trigger for transfer, is performed repeatedly and periodically, even if one transfer destination is randomly selected from among the transfer destination candidates, performing such transfer a plurality of times causes the cache information L to be held redundantly at locations close to the content location. Causing the cache information L to be held redundantly lowers the probability that the cache information L will disappear due to the exit of a node that is holding the cache information L. In the network 1, the cache information L is constantly held redundantly through transfers between nodes close to the content location, and therefore even if a node holding the cache information L leaves the network, there is no need for the registration source to perform re-registration or monitor whether a node has exited. Also, as a result of transferring the cache information L so as to be allocated close to the content location, there is an increased probability of finding a hit for obtaining the cache information L when an arbitrary node searches for the cache information L using the content location as the key.

Note that instead of making a random selection from among the transfer destination candidates, it is possible to randomly select a plurality of transfer destinations, or select all of the nodes that satisfy the condition (D1>D2) as transfer destinations.

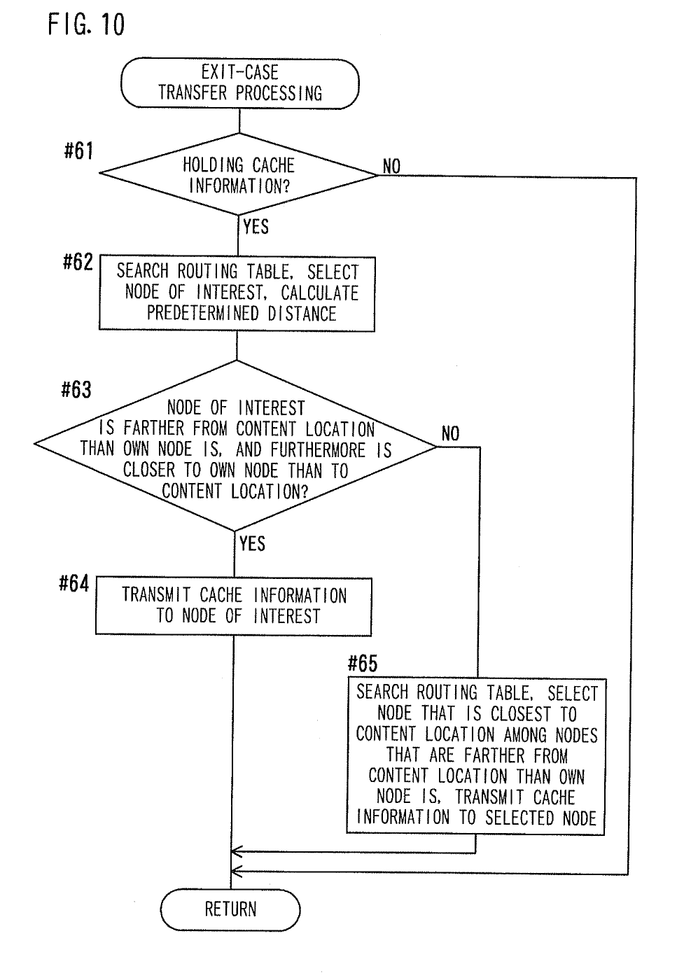

In the exit-case transfer processing illustrated in FIG. 10, substantial processing (steps S62 to S65) is executed only if the cache information L is held in the own node (YES in step S61). If the cache information L is not held in the own node, the execution of transfer processing is skipped.

The logical distance computation portion 20 extracts, from among the nodes registered in the routing table T1, a predetermined number of nodes in ascending order of the bucket number i. The logical distance computation portion 20 calculates the distances D1, D2, and D3 sequentially using the extracted nodes as the node of interest (step S62). The transfer destination selection portion 24 checks whether any of the nodes satisfies both a first condition that the distance D2 is greater than the distance D1 (D1<D2) and a second condition that the distance D3 is less than the distance D1 (D1>D3) (step S63). Each node that satisfies both the first condition and the second condition is determined to be a transfer destination candidate.

The transfer destination selection portion 24 selects the one node that is closest to the own node (has the smallest distance D3) among the transfer destination candidates that satisfy both the first condition and the second condition, as the transfer destination. The information transfer portion 26 then transfers the cache information L to the selected node (step S64). The first condition is satisfied if the node of interest is farther from the content location than the own node is. The second condition is a limiting condition that prevents the transfer destination from being too far from the content location.

If none of the predetermined number of nodes of interest satisfies both the first condition and the second condition (NO in step S63), the transfer destination selection portion 24 searches the routing table T1 and selects a node other than the node of interest as the transfer destination. The information transfer portion 26 then transfers the cache information L to that transfer destination (step S65). The transfer destination at this time is the node closest to the content location among the nodes that are farther from the content location than the own node is, and is selected as described below.

The logical distance computation portion 20 recognizes the most significant effective bit in the distance D1. For example, if the distance D1 is “001 . . . 011” in binary notation, the logical distance computation portion 20 recognizes the effective bit as viewed from the most significant bit side (the third bit). Furthermore, the logical distance computation portion 20 calculates a bit string Hx by inverting the bit next more significant than the third bit (i.e., the second bit as viewed from the most significant bit side) in the bit string indicating the content location, that is to say, the hash value of the content ID, which is H(content ID). The node closest to this calculated hash value Hx is selected as the transfer destination by the transfer destination selection portion 24. For example, in the case of simply using four bits, if the hash value of the node apparatus 10 is “1010”, and the hash value H(content ID) is “1001”, D1=1010̂1001=0011, and the third bit of D1 is the first effective bit as viewed from the most significant bit side. From among the nodes in the routing table T1 of the own node, the node apparatus 10 extracts the node closest to Hx=1101, which was obtained by inverting the second bit, which is the next more significant bit than the third bit of the hash value H(content ID), and the transfer destination selection portion 24 selects the extracted node as the transfer destination.

In this way, in the exit-case transfer processing, the cache information L is transferred to a node that is farther from the content location than the own node is, whether or not the first condition and the second condition are satisfied. In other words, the range in which the cache information L is held in the logical space is extended. As a result, even if the own node leaves the network, the range in which the cache information L is held in the logical space is not reduced, and there is a decrease in the probability that the cache information L will disappear from the network 1.

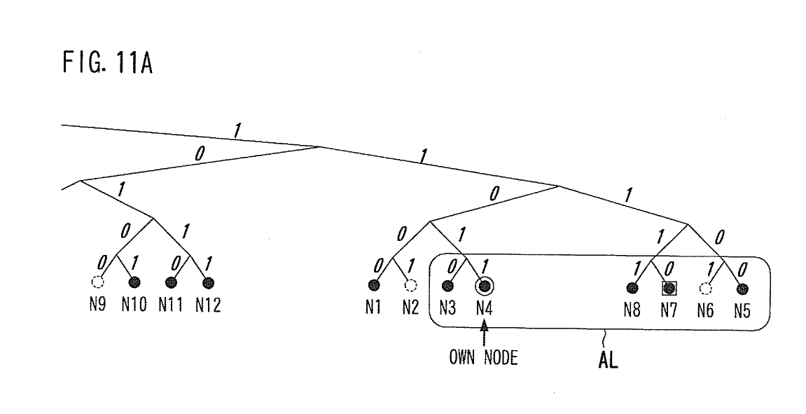

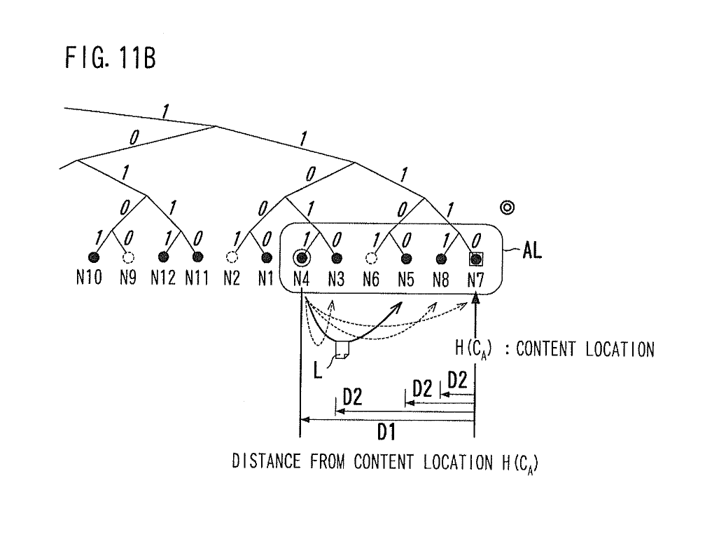

FIGS. 11A and 11B illustrate an example of the transfer of the cache information L in a normal case. Twelve nodes N1 to N12 whose bits that are more significant than the five least significant bits have the same value are illustrated in FIG. 11A. It is assumed that the three nodes N2, N6, and N9 among the twelve nodes have left the network 1, and the other nodes are participating. In FIG. 11A, the node N4 is assumed to be the own node, and FIG. 11A illustrates the near/far relationships that the own node N4 has with the other nodes.

The node apparatus 10 corresponding to the own node N4 is in the normal operation state after having completed the join processing, and transfers the cache information L using an adjacent node search as a trigger, as described above. The own node N4 transmits a search query to the node N3, which is an adjacent node from the viewpoint of the own node N4, and the response to the query is caused to be reflected in the routing table T1. Here, it is assumed that the own node N4 and the eight nodes N1, N3, N5, N7, N8, N10, N11, and N12 that are not nodes in the exit state are registered in the routing table T1. It is also assumed that the own node N4 and another four nodes N3, N5, N7, and N8 correspond to a space AL in which the cache information L regarding the content piece A is to be held redundantly. Furthermore, it is assumed here that the content location, which is the hash value (H(C_{A})) of the content ID of the content piece A, corresponds to the node N7.

The node apparatus 10 corresponding to the own node N4 calculates the distances D1 and D2 for, for example, the eight nodes N1, N3, N5, N7, N8, N10, N11, and N12 whose hash values are close to that of the content piece A, and selects transfer destination candidates. As described above, the transfer destination candidates are nodes that satisfy the condition of being closer to the content location than the own node N4 is (D1>D2). FIG. 11B illustrates the near/far relationships that the node N7, which is the content location, has with the other nodes.

As illustrated in FIG. 11B, the nodes N3, N5, N8, and N7 are the transfer destination candidates that satisfy the condition (D1>D2) in this example. The node apparatus 10 corresponding to the own node N4 transfers the cache information L to one node selected from among the candidates. In FIG. 11B, the cache information L is transferred to the node N5.

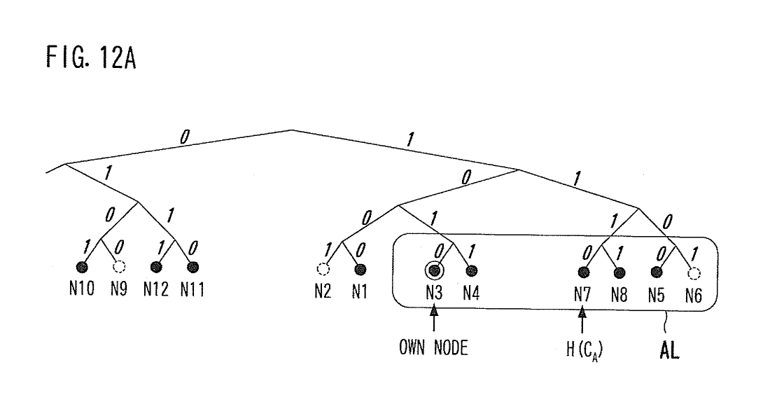

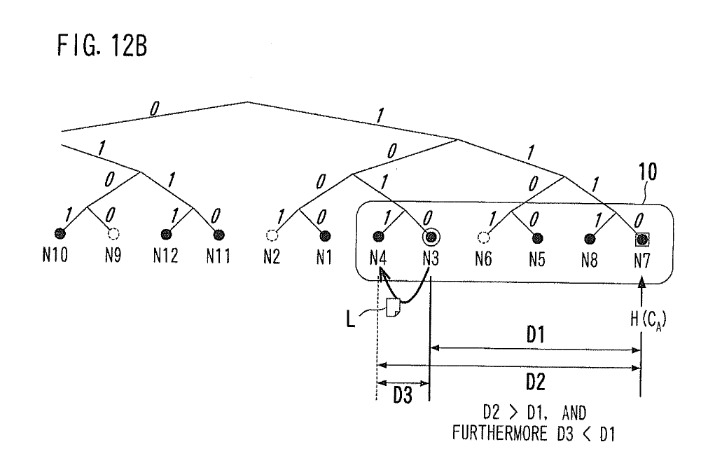

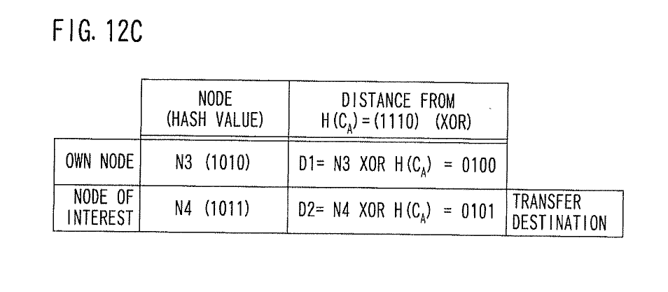

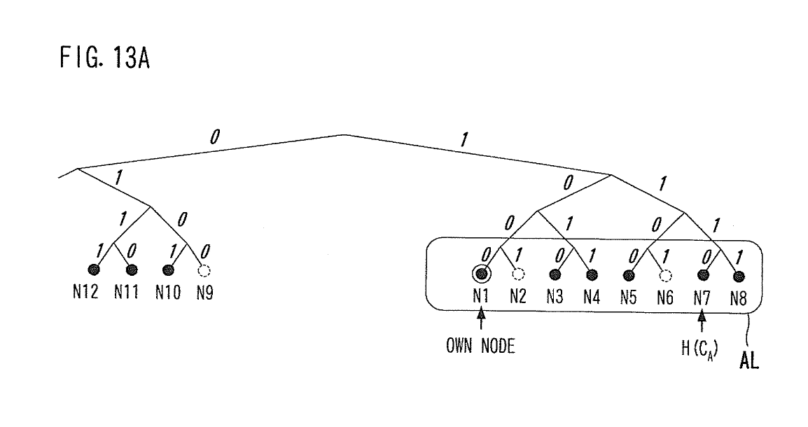

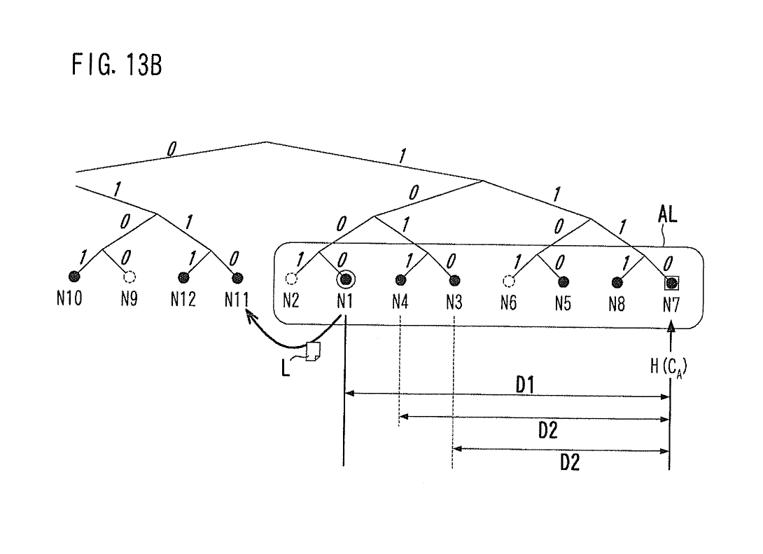

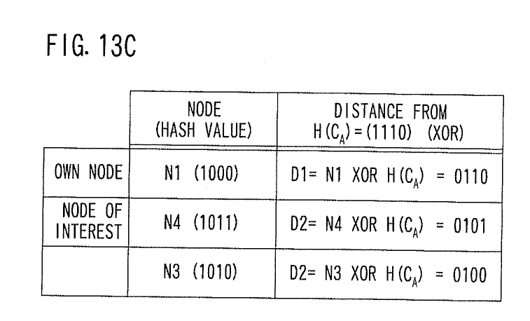

FIGS. 12A to 13C illustrate a first example and a second example of the transfer of the cache information L in the case of leaving the network. Similarly to the above-described case assumption in FIGS. 11A and 11B, twelve nodes N1 to N12 whose bits that are more significant than the five least significant bits have the same value are illustrated, and among these, the three nodes N2, N6, and N9 have left the network, and the other nodes are participating. In the first example in FIGS. 12A to 12C, the node N3 is the own node, and in the second example in FIGS. 13A to 13C, the node N1 is the own node. The content location corresponds to the node N7 in both the first example and the second example.

FIG. 12A illustrates the near/far relationships that the own node N3 has with the other nodes, and FIG. 12B illustrates the near/far relationships that the node N7, which is the content location, has with the other nodes. FIG. 12C illustrates specific values of the distances D1 and D2.

In the first example in FIGS. 12A to 12C, the node apparatus 10 corresponding to the own node N3 calculates the distances D1, D2, and D3 for, for example, the five nodes N1, N4, N5, N7, and N8 whose hash values are close to that of the content piece A, and determines whether the nodes are transfer destination candidates. The transfer destination candidates are, as described above, the nodes that satisfy the first condition of being farther from the content location than the own node N3 is (D1<D2) and furthermore the satisfy the second condition of not being too far from the content location (D1>D3). The node apparatus 10 corresponding to the own node N3 selects the node closest to the own node N3 among the transfer destination candidates to be the transfer destination. In this example, the node N4, which is an adjacent node with respect to the own node N3, is selected as the transfer destination candidate, and the cache information L is transferred to the node N4.

In the second example in FIGS. 13A to 13C, the node apparatus 10 corresponding to the own node N1 calculates the distances D1, D2, and D3 for, for example, the five nodes N3, N4, N5, N7, and N8 whose hash values are close to that of the content piece A, and determines whether the nodes are transfer destination candidates. In this example, none of the five nodes N3, N4, N5, N7, and N8 satisfy the first condition (D1<D2). In view of this, the node apparatus 10 corresponding to the own node N1 transfers the cache information L to the node N11, which is the closest to the content location among the nodes that are farther from the content location than the own node N1 is.

[Node Apparatus According to Second Example]

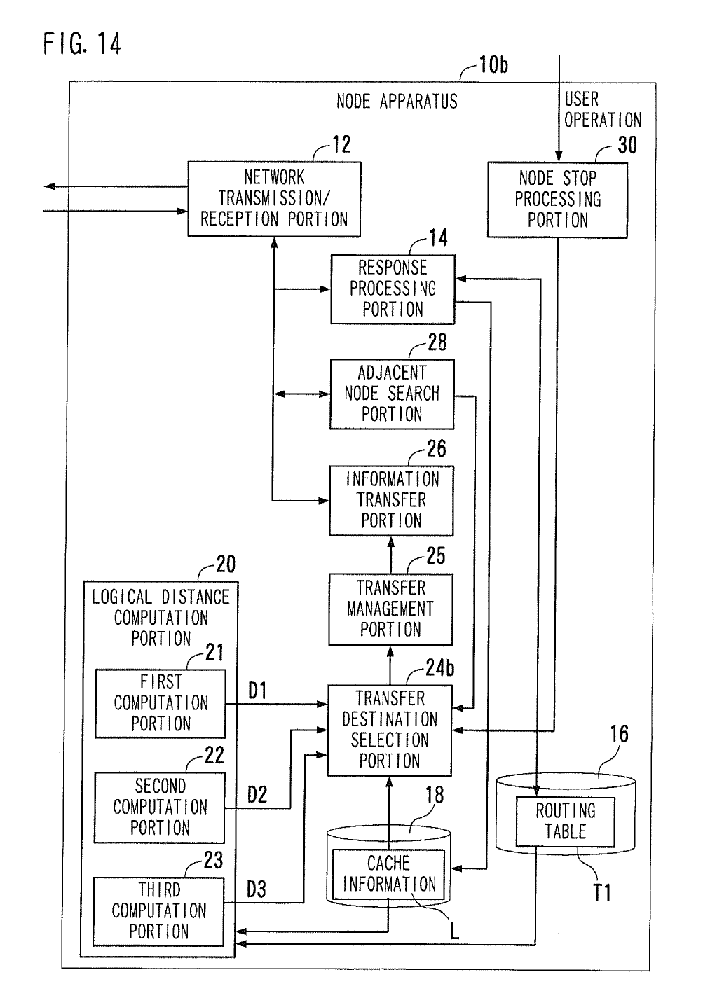

The configuration of a node apparatus 10b illustrated in FIG. 14 is substantially the same as the configuration of the node apparatus 10 illustrated in FIG. 5. They are different in that the node apparatus 10b includes a transfer management portion 25, and also includes a transfer destination selection portion 24b instead of the transfer destination selection portion 24 of the node apparatus 10. A description of the constituent elements of the node apparatus 10b that are the same as those of the node apparatus 10 has been omitted. The same reference signs have been given to the same constituent elements.

The transfer management portion 25 reduces the number of times that the cache information L is transferred in a normal case. Specifically, the transfer management portion 25 suspends the notification of a transfer destination from the transfer destination selection portion 24b to the information transfer portion 26 in accordance with the location of the own node as will be described later, thus reducing the frequency with which the information transfer portion 26 operates. Reducing the number of transfers prevents a plurality of nodes, including the own node, that hold the same cache information L from exchanging the cache information L with each other at the same frequency. In other words, the number of messages that generate traffic in the network 1 is reduced.

In normal cases and in the case of leaving the network, the transfer destination selection portion 24b selects a transfer destination for the cache information L in basically the same manner as the transfer destination selection portion 24 of the node apparatus 10 illustrated in FIG. 5. When the cache information L is to be transferred in the case of leaving the network, the transfer destination selection portion 24b changes the number of transfer destinations in accordance with the distance D1 between the own node and the content location as described below.

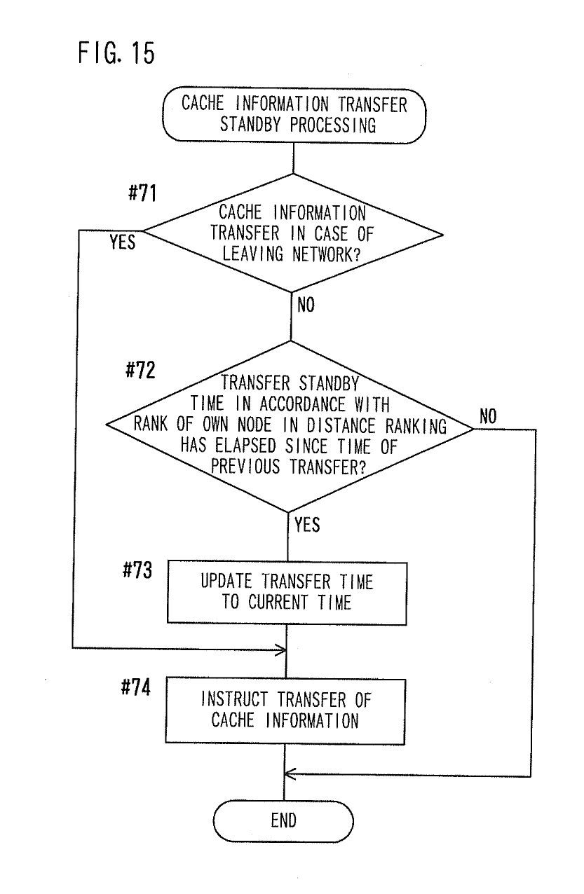

FIG. 15 illustrates the flow of cache information transfer standby processing executed by the transfer management portion 25.

Upon receiving a notification of a transfer destination from the transfer destination selection portion 24b, the transfer management portion 25 checks whether this is a transfer in the case of leaving the network (step S71). If this is a transfer in the case of leaving the network (YES in step S71), transfer needs to be performed, and therefore the transfer management portion 25 proceeds to step S74 in which the transfer management portion 25 gives the information transfer portion 26 a notification of a transfer destination and an instruction to perform transfer.

If this is not a transfer in the case of leaving the network (NO in step S71), the transfer management portion 25 checks whether the elapsed time since the time of the previous transfer has exceeded a transfer standby time that is in accordance with the rank of the own node in a distance ranking (step S72). If the elapsed time has exceeded the transfer standby time (YES in step S72), the transfer management portion 25 updates the time of transfer to the current time (step S73), and instructs the information transfer portion 26 to perform transfer (step S74). On the other hand, if the elapsed time has not exceeded the transfer standby time (NO in step S72), the transfer management portion 25 ends the cache information transfer standby processing without instructing the information transfer portion 26 to perform transfer. As a result, in this case, the notification of a transfer destination from the transfer destination selection portion 24b becomes invalid, and the number of transfers is reduced.

The transfer standby time (M) is the product of the rank of the own node in a distance ranking (R), a constant (m), and a unit time (e.g., 1 sec), that is to say, M=R×m·sec. Also, the rank of the own node in the distance ranking refers to the rank of the own node when the nodes that are to hold the cache information L are counted in order of decreasing distance from the content location at the current time, and is defined as the difference between the set reference number of nodes that are to hold the cache information L and the number of transfer destination candidates. The smaller the number of transfer destination candidates, the lower the rank of the own node in the distance ranking (i.e., the higher the rank value). The closer the own node is to the content location, the fewer the number of transfer destination candidates. Accordingly, the closer the own node is to the content location, the higher the value of the rank of the own node in the distance ranking, and the longer the transfer standby time.

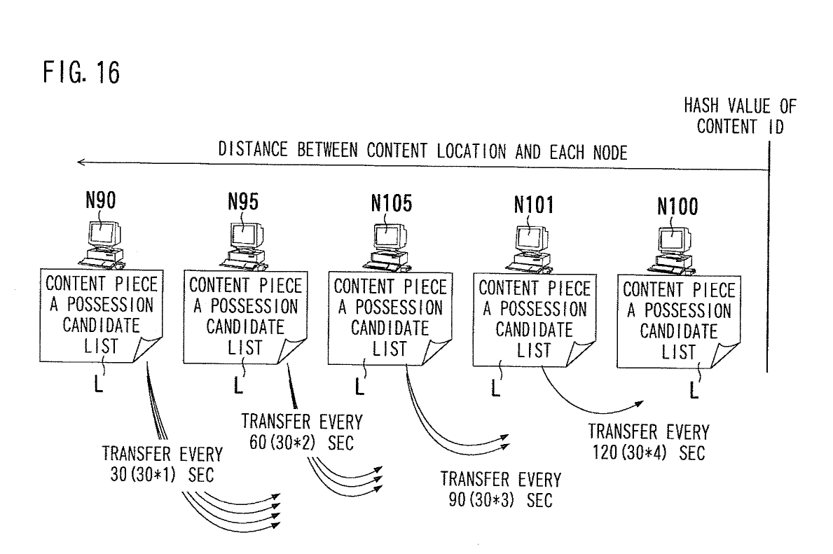

FIG. 16 illustrates an example of a reduction in the number of transfers. In FIG. 16, five nodes N90, N95, N105, N101, and N100 are close to the content location. It is assumed that the set reference number of nodes that are to hold the cache information L is 5. If the node N90 that is farthest from the content location is the own node, the four nodes N95, N105, N101, and N100 are the transfer destination candidates. Since the number of candidates is 4, the rank of the own node in the distance ranking is the value of 1, obtained by subtracting 4 from 5, which is the set reference number. Assuming that the constant is 30, the transfer standby time is 30 sec. Every 30 sec, the node N90 transfers the cache information L to one node randomly selected from among the four candidates. In accordance with the same procedure, the cache information L is transferred to a node closer to the content location by the node N95 (the second farthest from the content location) every 60 sec, by the third farthest node N105 every 90 sec, and by the fourth farthest node N101 every 120 sec.

When transferring cache information in a normal case, a transfer destination is repeatedly selected at a cycle that is shorter than a time obtained by multiplying the constant by the unit time. The transfer destination candidates are not fixed, and a node that has newly joined the network may also be a candidate. The candidates are dependent on response results sent from other nodes in response into a search query periodically transmitted by the adjacent node search portion 28. In transfer in a normal case, there is no need for the number of transfer destinations selected from among the transfer destination candidates to be one. It is possible to change the number of transfer destinations in accordance with the distance from the content location, such as a larger number when the own node is far from the content location, and a smaller number when the own node is close to the content location.

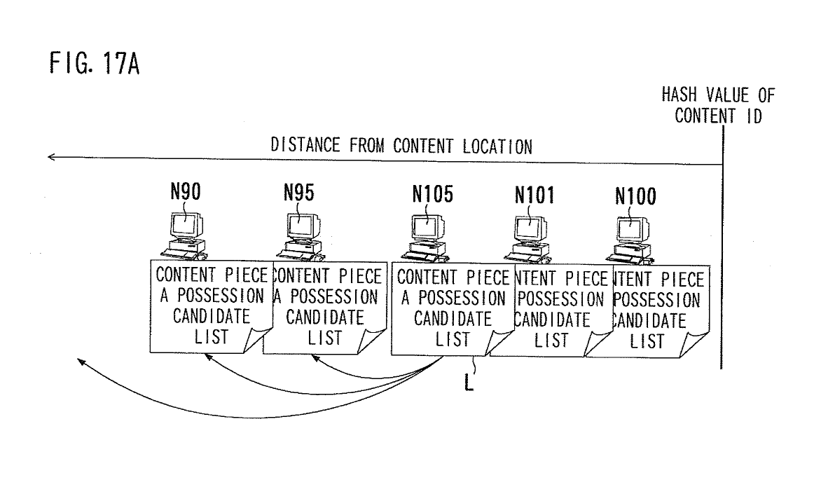

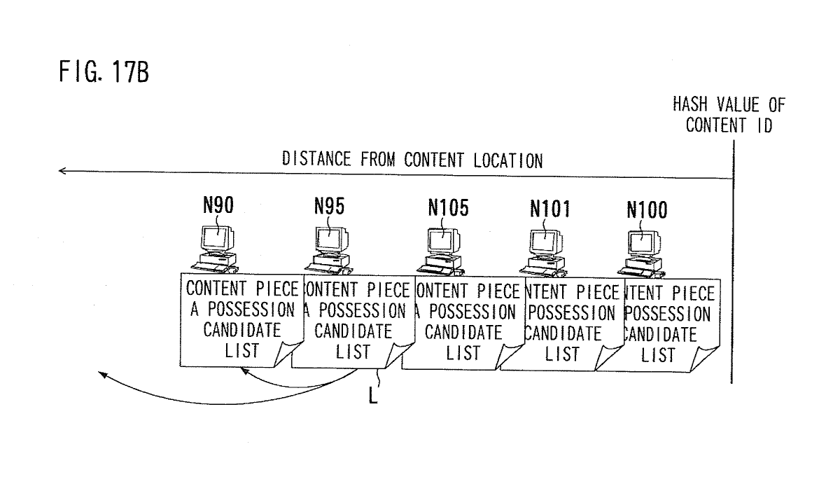

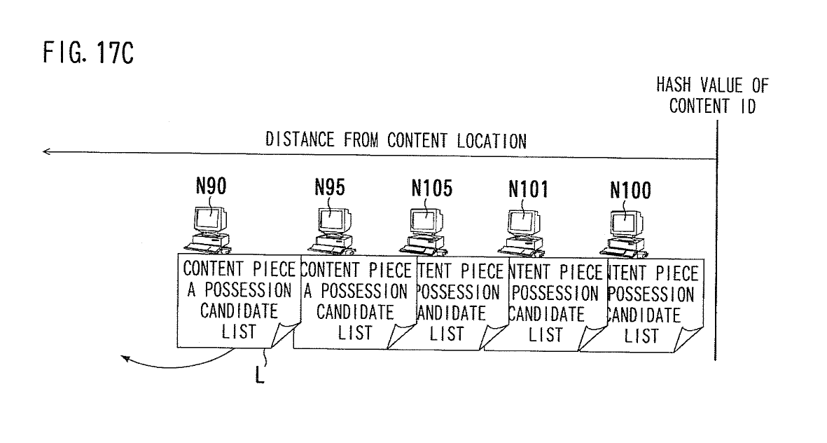

FIGS. 17A to 17C illustrate an embodiment of cache information transfer in the case of leaving the network. In the case of selecting a transfer destination using the fact that an instruction causing the own node to leave the network 1 has been given as a trigger, the transfer destination selection portion 24b selects a larger number of transfer destinations the smaller the distance calculated by the first computation portion.

In the example of FIG. 17A, the node N105 is the own node, and the node N105 transfers the cache information L to three nodes that are farther from the content location than the own node is, including the nodes N95 and N90. In the example of FIG. 17B, the node N95 is the own node, and the node N95 transfers the cache information L to two nodes that are farther from the content location than the own node is, including the node N90. In the example of FIG. 17C, the node N90 is the own node, and the node N90 transfers the cache information L to only one node that is farther from the content location than the own node is. The reason why the number of transfer destinations is decreased the farther the own node is from the content location, is that the farther the own node is from the content location, the lower the probability of receiving a search request in which the content location is the key. There is not much need for the cache information L to be held at a location far from the content location.

According to the above-described embodiment, the cache information L is held redundantly due to the registration destination of the cache information L transferring the cache information L to nodes in the vicinity thereof, thus eliminating the need for the registration source of the cache information L to store the registration destinations, to re-register a registration destination when a registration destination has left the network, or the like. Since the cache information is transferred between nodes whose hash values are close, there is no possibility of an increase in the number of messages due to the cache information L being transferred in a bucket-brigade manner until converging in accordance with the DHT in order to perform re-registration.

When the own node searches for an adjacent node in order to maintain routing in the overlay network, the own node selects a transfer destination for the cache information L that it itself is holding, and therefore the cache information L may be transferred at the same time as recognizing the existence of the adjacent node apparatus.

In the case of leaving the network, the cache information L is spread out by being transferred to a node that is farther from the object location than the own node is, thereby enabling the cache information L to continue to be held redundantly even if a node holding the cache information L has left the network.

Changing the number of transfer destinations for the cache information L in accordance with the distance from the own node to the object location enables the cache information L to be more reliably held by a node that is closest to the object location and is most needed to hold the cache information L.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A node apparatus capable of communicating, as a node in an overlay network, with another node in the overlay network, the node apparatus comprising:
a second computation portion that references cache information held by the own node corresponding to the node apparatus, the cache information indicating a node holding an object that is a search target in the overlay network in association with the object, and calculates, with respect to the object corresponding to the node indicated in the cache information, a distance between an object location and a node of interest in a logical space in which the overlay network is constructed, the object location being a logical location of the object, and the node of interest being a node other than the own node;
a transfer destination selection portion that selects a transfer destination to which the cache information is to be transferred, based on the distance calculated by the second computation portion; and
an information transfer portion that transfers the cache information to the transfer destination selected by the transfer destination selection portion.

2. The node apparatus according to claim 1, further comprising:
a first computation portion that calculates a distance between the own node and the object location that is the logical location of the object in the logical space in which the overlay network is constructed,
wherein the second computation portion references routing information held in the node apparatus that indicates communication party selection options, and performs distance calculation with use of a node indicated in the routing information as the node of interest, and
the transfer destination selection portion selects, as the transfer destination, a node for which the distance calculated by the second computation portion is less than the distance calculated by the first computation portion.

3. The node apparatus according to claim 1, further comprising:
an adjacent node search portion that searches for an adjacent node that is adjacent to the own node in the logical space,
wherein using execution of the search by the adjacent node search portion as a trigger, the transfer destination selection portion selects a transfer destination, and the information transfer portion transfers the cache information to the selected transfer destination.

4. The node apparatus according to claim 1, further comprising:
a third computation portion that calculates a distance between the own node and the node of interest other than the own node in the logical space,
wherein using a giving, to the node apparatus, of an instruction causing the own node to leave the overlay network as a trigger,
the second computation portion and the third computation portion perform distance calculation with use of a node indicated in the routing information as the node of interest,
the transfer destination selection portion selects a node as the transfer destination from among one or more nodes for which the distance calculated by the second computation portion is greater than the distance calculated by the first computation portion, based on the distance calculated by the third computation portion, and
the information transfer portion transfers the cache information to the node selected as the transfer destination.

5. The node apparatus according to claim 1, further comprising:
a transfer management portion that reduces the number of transfers performed by the information transfer portion,
wherein in a state in which the node apparatus participates in the overlay network as the own node, the transfer management portion reduces the number of transfers by a greater percentage the smaller the number of nodes between the own node and the object location.

6. The node apparatus according to claim 4, wherein in a case of selecting a transfer destination using the giving of the instruction causing the own node to leave the overlay network as a trigger, the transfer destination selection portion selects a larger number of transfer destinations the smaller the distance calculated by the first computation portion.

7. A computer-readable storage medium storing thereon a computer program executed in a node apparatus capable of communicating, as a node in an overlay network, with another node in the overlay network, the computer program causing the node apparatus to operate as:
a second computation portion that references cache information held by the own node corresponding to the node apparatus, the cache information indicating a node holding an object that is a search target in the overlay network in association with the object, and calculates, with respect to the object corresponding to the node indicated in the cache information, a distance between an object location and a node of interest in a logical space in which the overlay network is constructed, the object location being a logical location of the object, and the node of interest being a node other than the own node;
a transfer destination selection portion that selects a transfer destination to which the cache information is to be transferred, based on the distance calculated by the second computation portion; and
an information transfer portion that transfers the cache information to the transfer destination selected by the transfer destination selection portion.
